(19) United States
(12) Patent Application Publication
(10) Pub. No.: US 2016/0150844 A1
(43) Pub. Date: Jun. 2, 2016

(54) ILLUMINATING HELMET COVER

(71) Applicant: Aysheta Das, Pleasanton, CA (US)

(72) Inventor: Aysheta Das, Pleasanton, CA (US)

(21) Appl. No.: 14/603,140

(22) Filed: Jan. 22, 2015

Related U.S. Application Data
(60) Provisional application No. 61/930,924, filed on Jan. 23, 2014.

(51) Int. Cl. A42B 3/04; F21L 4/02; H05B 33/08; F21L 4/08; G02B 5/136; A42B 3/00; F21L 4/06

(52) U.S. Cl. CPC A42B 3/044; A42B 3/003; F21L 4/02; F21L 4/06; F21L 4/08; G02B 5/136; H05B 33/0845; H05B 33/0857

(57) ABSTRACT

An illuminating helmet cover configured to connect with a helmet, such as a motorcycle helmet, bicycle helmet, construction helmet, or the like. The illuminating helmet cover includes a plurality of illuminating elements, such as light-emitting diodes, lamps, or reflective surfaces, which allow a user to be more easily visible. The plurality of illuminating elements are coupled with one or more strands that are configured to extend over the helmet, such as in the form of a netting. The illuminating helmet cover fastens with the helmet via one or more coupling components, such as clamps, hooks, adhesives, Velcro, etc. A power source is connected with the one or more strands for providing power to one or more of the plurality of illuminating elements. Operation of the plurality of lights may he customized by the user, for example, by changing colors, strobe patterns, and/or brightness or intensity.

### CROSS REFERENCE TO RELATED APPLICATIONS

This application claims the benefit of U.S. Provisional Patent Application Ser. No. 61/930,924, filed on Jan. 23, 2014, entitled ILLUMINATED HELMET COVER,” which is hereby incorporated by reference in its entirety.

### BACKGROUND

1. Field of the Invention

The present invention relates to a method and system for visually illuminating apparel or equipment worn by a user. More particularly, the present invention relates to an illuminated cover or netting that is configured to fasten to motorcycle, bicycle, or other helmets for providing improved safety to the user.

2. Description of the Related Art

Cycling is a popular outdoor activity that is enjoyed by a wide percentage of the world population. Not only does the activity allow users to engage in an athletic activity outside of their home for fitness or exercise purposes, but also allows individuals to easily travel from one geographic location to another without consuming the increasingly diminished, and expensive, energy sources. Even for motorized cycles, such as scooters, dirt-bikes, motorcycles, all-terrain vehicles, etc., fuel consumption is often lower than the larger vehicles on the roadway, commonly cars and trucks. These vehicles also can provide gratification to their users through the sensation of being outside in the environment, free from the constraints of typical vehicle interiors.

However, both manual cycling and motorized cycling inherently include significant safety risks for those individuals participating in them, especially when cycling upon busy roadways that are also used by the more common, and heavier, trucks and automobiles. In a collision, a rider upon a bicycle or, motorized cycle is in a much greater risk of injury or death due to the relative lack of protection for the rider's body. Many such collisions result from the riders of bicycles or other motorized cycles not being seen by other users on the roadway. This is often the case because bicycles and other motorized cycles are much less common on roadways so other drivers have not been conditioned to looking for these smaller vehicles.

A variety of methods have been employed to help increase the visibility of riders engaged in cycling activity, such as reflective strips, bright clothing, and blinking lights that users may wear or otherwise fasten to the bike frame itself. In addition, many U.S. state laws require riders to wear safety helmets in an effort to reduce serious head injuries in the event of a crash. Even in those U.S. states or foreign countries where not required, safety helmets of this nature are still commonly worn by riders hoping to reduce the risk of significant bodily injury.

Although primarily used for safety purposes, helmets, like other forms of clothing worn by people, have become fashionable. Riders may choose among a variety of helmet aesthetics that exhibit different paint schemes, graphics, logos, text, or other accessories or enhancements (e.g., “Mohawks,” antennas, etc,) that can make the helmet more individualized, fashionable, distinguishable, or visually appealing for the rider. Individual riders have also settled towards favorite brands or styles of helmets. Because of this, many riders may be brand loyal, or at least may be hesitant to purchase a new helmet that strays from their preferred look, even if a new helmet includes improved safety features. This same type of concern is also present for other types of helmets, such as construction hats, etc.

Thus, an improved safety device for use with helmets would not require a user to purchase a brand new helmet in order to make use of its improved functionality or safety, but instead may be added or incorporated into the existing or standard helmet. This would allow a user to keep their existing helmet or to purchase the type of helmet that is most desired by the user, without also having to give up on specific safety features that may not be a part of the purchased helmet itself.

### SUMMARY

The present invention is related to a method and system for an illuminated helmet apparatus or cover. In one embodiment, an illuminated helmet cover may include an illuminating element, a strand connected with the illuminating element, the strand configured to extend around at least a portion of the helmet, and a connecting component configured to engage with the strand and configured to engage with the helmet for holding the strand and the helmet together.

In another embodiment, an illuminating helmet cover for a helmet may include a connecting component configured to engage with the helmet, a power source configured to engage with the helmet, a strand configured to connect with the connecting component, a conductive material connected with the power source and connected with the strand, and an illuminating element electrically connected with the conductive material and positioned at the connection of the conductive material with the strand.

In still another embodiment, an illuminated helmet cover for placement around at least a portion of a helmet may include a strand made of an elastic material, the strand configured to be placed around at least a portion of the helmet, an illuminating element that requires power to illuminate, the illuminating element connected to the strand at a node, and a power source for providing power to the illuminating element. The power source may include an external case and a clasp connected with the external case and configured to engage with an edge of the helmet for securing to the helmet. The illuminating helmet cover may also include a wire configured to conduct power from the power source to the illuminating element, the wire connected to the strand at the node, and a clamp configured to connect with the strand and configured to engage with an edge of the helmet for securing to the helmet.

### BRIEF DESCRIPTION OF THE DRAWINGS

The features, objects, and advantages of the present invention will become more apparent from the detailed description set forth below when taken in conjunction with the drawings, wherein:

FIG. 1 shows a side view of a helmet coupled with an illuminated helmet cover, according to one embodiment of the present invention;

FIG. 2 shows a top view of an illuminated helmet cover, according to one embodiment of the present invention;

FIG. 3 shows a rear perspective view of a helmet coupled with an illuminated helmet cover, according to one embodiment of the present invention;

FIG. 4 shows a top view of an illuminated helmet cover, according to one embodiment of the present invention;

FIG. 5A shows a side view of a clamp for connecting an illuminated helmet cover with a helmet, according to one embodiment of the present invention;

FIG. 5B shows a side view of the clamp of FIG. 5A connected with a helmet, according to one embodiment of the present invention;

FIG. 5C shows a side view of a plurality of clamps of FIG. 5A connected with a helmet, according to one embodiment of the present invention;

FIG. 5D shows a top view of a connecting element used with the clamp of FIG. 5A for connecting an illuminated helmet cover with a helmet, according to one embodiment of the present invention;

FIG. 6A shows a zoomed-in view of a power source for an illuminated helmet cover, according to one embodiment of the present invention; and

FIG. 6B shows side views of the power source of FIG. 6A for connection with a helmet, according to one embodiment of the present invention.

### DETAILED DESCRIPTION

The detailed description of exemplary embodiments herein makes reference to the accompanying drawings and pictures, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

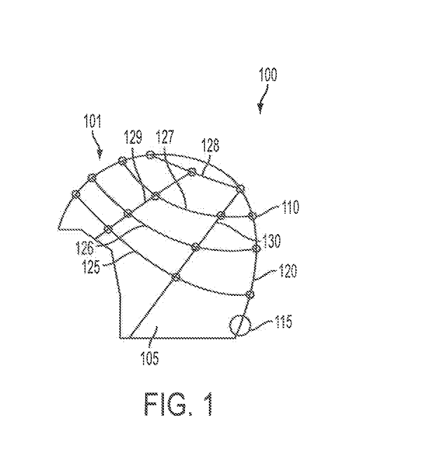

Turning first to FIG. 1, a side view 100 of a helmet 105 coupled with an illuminated helmet cover 101 is shown. The helmet 105 may be any of a variety of helmet types, for example, a motorcycle helmet, a bicycle helmet, a construction helmet, etc. The helmet 105 may be of a type that has certain dimensions or features that are standardized, such that those dimensions or features are the same or similar across all helmets of the same type.

The illuminated helmet cover 101 includes a plurality of lights or lighted nodes 110 (e.g., light emitting diodes (“LEDs”) or micro LEDs) that are distributed on the illuminated helmet cover 101. Although multiple lights or lighted nodes 110 are illustrated in FIG. 1, in an alternative embodiment only a single light or lighted node 110 may be used. Moreover, the plurality of lights or lighted nodes 110 may be any of a variety of illuminating components, whether powered or unpowered, such as diodes, lamps, fluorescent or other lights, reflective surfaces, etc. In addition, the plurality of lights or lighted nodes 110 may be any of a variety of shapes, sizes, or colors in differing embodiments. For embodiments employing powered lights, one or more of the plurality of lights or lighted nodes 110 may be configured to remain ON during use or may be configured to blink, strobe, or otherwise change in brightness and/or intensity.

The illuminated helmet cover 101 includes a strap or portion 120 (e.g., made of an elastic or other stretchy material) that permits the illuminated helmet cover 101 to be stretched or otherwise pulled or fit over at least a portion of an exterior surface of the helmet 105. In an alternative embodiment, the strap or portion 120 may not be elastic or stretchy, but instead or additionally may include one or more of a coupling component, such as a buckle, snap, screw, adhesive, etc, that operates to connect the illuminated helmet cover 101 in place upon the helmet 105. The strap or portion 120 may operate to hold the illuminated helmet cover 101 in place upon the helmet 105. In certain embodiments, the strap or portion 120 may be the only component of the illuminated helmet cover 101 required to hold the illuminated helmet cover 101 in place. This may be the case, for example, on helmets where the user of the helmet is remaining in a substantially stationary or slow-moving position (e.g., road construction personnel for directing traffic). In an alternative embodiment, additional or alternative components may be necessary for holding the illuminated helmet cover 101 in place.

The strap or portion 120 of the illuminated helmet cover 101 may include one or more of first strands or bands (125, 126, 127, 128) are interconnected in order to provide a netting or cover for which the plurality of lights or lighted nodes 110 are coupled thereto. The first strands or bands (125, 126, 127, 128) may be made out of a variety of materials and of a variety of shapes, sizes, and/or dimensions (e.g., thin strong fibers, a hard bungee cord (e.g., with a thickness of 3 mm or less), such as to form a netting). One or more of the first strands or bands (125, 126, 127, 128) of the strap or portion 120 may be made out of the same or out of different materials. In the embodiment shown in FIG. 1, four strands or bands (125, 126, 127, 128) are illustrated and extend concentrically around the helmet 105 if the helmet 105 were viewed from a top perspective.

Similarly, the strap or portion 120 of the illuminated helmet cover 101 may also include one or more of second strands or bands (129, 130). The second strands or bands (129, 130) may have the same or similar features as those previously discussed for the first strands or bands (125, 126, 127, 128). In the embodiment shown in FIG. 1, two strands or bands (129, 130) are illustrated and extent downwardly from the top of the helmet 105 if the helmet 105 were viewed from a top perspective. At each intersection of the first strands or bands (125, 126, 127, 128) and the second strands or bands (129, 130) one of the plurality of lights or lighted nodes 110 is fastened thereto. Thus, the helmet 105 has the plurality of lights or lighted nodes 110 spaced around its exterior surface when the illuminated helmet cover 101 is coupled with the helmet 105. In an alternative embodiments, greater or fewer strands or bands (125, 126, 127, 128, 129, 130) having the same or different properties may be used.

To power the plurality of lights or lighted nodes 110, the illuminated helmet cover 101 includes a power source 115 (e.g., a battery pack). The power source 115 is electrically connected with each of the plurality of lights 110 that require power to properly function. The power source 115 may be a rechargeable power source, such that a user can plug in the power source 115 for recharge, or may include a case or container configured to accept one or more removable components (e.g., batteries, such as AA batteries or AAA batteries) and transmit the energy from such removable components towards the one or more of the plurality of lights or lighted nodes 110. In an alternative embodiment where the plurality of lights or lighted nodes 110 do not require power (e.g., the lights are reflective surfaces or materials), no power source 115 may be needed. In still another embodiment, the power source may be capable of generating energy due to movement of the user or from solar energy, for example by incorporating kinetic and/or solar cell components therein for providing power to the lights or lighted nodes 110.

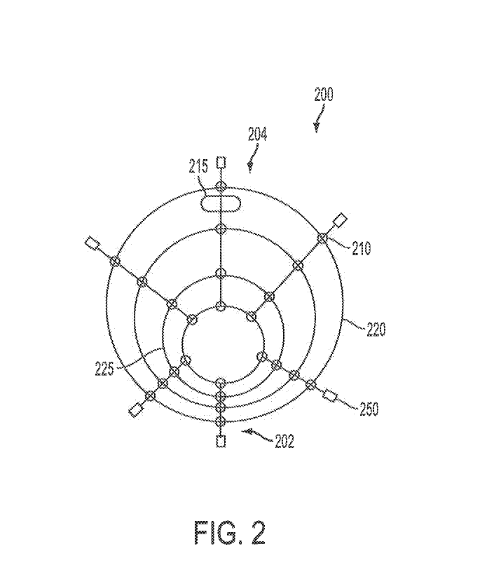

For certain applications, additional fastening components may be desired to aid in holding the illuminated helmet cover 101 in place beyond fitment of the strap or portion 120 over the helmet 105. For example, motorcycle helmets may use a more secure fastening method in order to maintain the illuminated helmet cover 101 in a desired position due to the fast speeds and increased wind resistance that the motorcycle helmet can encounter during use. Turning next to FIG. 2, a top view of an illuminated helmet cover 200 having a front 202 and a rear 204 is shown that includes additional securing functionality for coupling with a helmet. The illuminated helmet cover 200 is not illustrated connected to any helmet, but may contain features that are the same as or similar to those previously discussed.

The illuminated helmet cover 200 includes a plurality of lights or lighted nodes 210, powered by a power source 215, that are coupled with a strap or portion 220 having one or more strands or bands 225, the same as or similar to those previously discussed. In an alternative embodiment, no power source 215 may be necessary if the plurality of lights or lighted nodes 210 do not require power to illuminate (e.g., are reflective surfaces or materials). The strap or portion 220 (whether elastic or not) is configured to fit around a portion of a helmet for helping maintain the illuminated helmet cover 200 in a desired position upon the helmet.

A plurality of coupling components 250 are coupled with at least some of the strap or portion 220 that has one or more strands or bands 225 for providing additional securing functionality of the illuminated helmet cover 200 to a helmet. For example, one or more of the coupling components 250 may be hooks or clamps that are configured to engage with a portion of a motorcycle helmet to fasten the illuminated helmet cover 200 to the motorcycle helmet, even when the motorcycle helmet is traveling at high speeds with significant wind resistance. In one embodiment, the strap or portion 220 that has strands or bands 225 may be a separate wire or other mesh created of an elastic or rubber material in a cobweb design that is placed around the helmet and configured to hook around a bottom rim of the helmet. An elastic, rubber, or other stretchy material may allow for manufacturing in a minimal amount of sizes (or one-size-fits-all) that is configured to fit a variety of helmet types and sizes and therefore stretch as needed to secure with the helmet.

The plurality of lights or lighted nodes 210 are attached to the mesh created by the strap or portion 220 that has strands or hands 225. When the mesh is stretched and hooked onto the helmet, the nodes may help place and hold the attached LED lights in place. In an alternative embodiment, one or more of the coupling components 250 may additionally or alternatively include other fastening components, such as Velcro, adhesives, bolts, clamps, clips, etc. In this fashion, a user may use the illuminated helmet cover 200 with helmets already owned or used by the user in an effort to add the additional illumination safety features to the helmet. A user is thus not required to purchase a new helmet with embedded lights or lights otherwise attached for the improved safety inherent in additional illumination, but can continue using or shopping for helmets that the user already prefers.

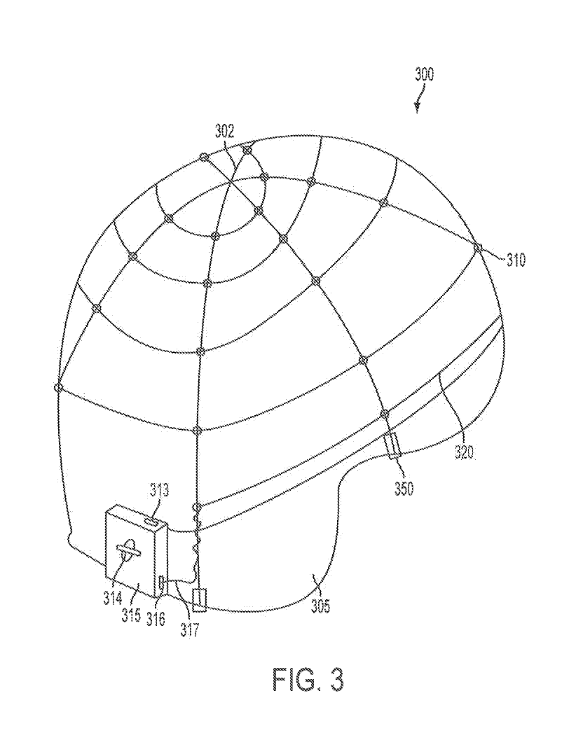

FIG. 3 shows a rear perspective view 300 of a helmet 305 coupled with an illuminated helmet cover 320. The illuminated helmet cover 320 may include features that are the same as or similar to those previously discussed. The illuminated helmet cover 320 is configured to connect or secure with the helmet 305, for example, via one or coupling components 350, such as clips, clamps, or others as previously discussed. The illuminated helmet cover 320 may be made of one or more strands or hands that are connected at various nodes with one another in order to form a netting (e.g., of a cobweb form) such that it may be placed around all or a portion of the helmet 305. For example, multiple of the strands or bands may connect at a center point top node 302 and spiral downward, as illustrated. At one or more of the various interconnected nodes, one or more illuminating elements 310, such as lights, lamps, LEDs, reflective materials, etc. may be connected therewith. In embodiments where the illuminating elements 310 require power (e.g., LEDs), a power source 315 battery pack) is also connected with one or more of the strands or bands that make up the illuminated helmet cover 320. In another embodiment, the power source 315 may not be connected with any strands or bands and may be configured to power the lights by connecting on its own to the helmet 305 or configured to be located remotely from the helmet 305 (e.g., placed within a pocket of the user). In still another embodiment, additional or fewer power sources 315 may be used, and/or may be of varying types (e.g., solar, kinetic, etc.)

The power source 315 includes an indicator 313 (e.g., a light) to notify a user whether the power source is providing power and/or how much power remains in the power source 315 for powering one or more of the illuminating elements 310. A switch or other interfaceable element 317 may be manipulated by the user to turn the power of the power source 315 ON or OFF for powering one or more of the illuminating elements 310. This power may be delivered by one or more wires or other conductive element 317. In certain embodiments, the conductive element 317 may be disposed along one or more of the strands or bands that make up the illuminating helmet cover 320. In another embodiment, the conductive element 317 itself may be used to form the strands or bands that make up the illuminating helmet cover 320 (e.g., may be made of stretchable electric cords configured to transmit power or energy). A connecting component 314 is coupled with the power source 315 for connecting the power source 315 to the helmet 305.

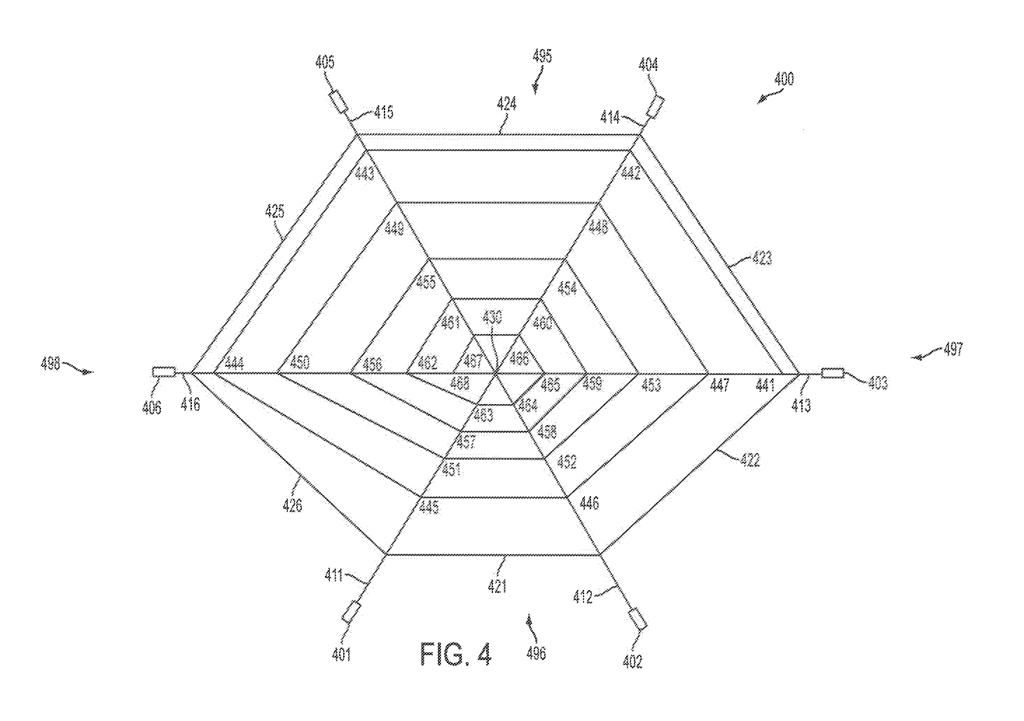

FIG. 4 shows a top view 400 of an illuminated helmet cover made up of a plurality of strands, as discussed in greater detail below, in order to form a cobweb shape. The illuminated helmet cover has a front side 495, a rear side 496, a right side 497, and a left side 498. The illuminated helmet cover may include features that are the same as or similar to those previously discussed. The illuminated helmet cover is configured to connect with a helmet via one or more connecting elements (401, 402, 403, 404, 405, 406), such as damps. Each of these connecting elements (401, 402, 403, 404, 405, 406) are connected with a respective strand (411, 412, 413, 414, 415, 416), these respective strands (411, 412, 413, 414, 415, 416) being fused or otherwise connected together at the center point top node 430.

An electrical cord or other conductive material, which may include a surrounding insulating material, connects in a spiral format to these respective strands (411, 412, 413, 414, 415, 416) to form a plurality of nodes (441, 442, 443, 444, 445, 446, 447, 448, 449, 450, 451, 452, 453, 454, 455, 456, 457, 458, 459, 460, 461, 462, 463, 464, 465, 466, 467, 468). At one or more of these plurality of nodes (441, 442, 443, 444, 445, 446 447, 448, 449, 450, 451, 452, 453, 454, 455, 456, 457, 458, 459, 460, 461, 462, 463, 464, 465, 466, 467, 468), one or more illuminating elements may be connected, such as LEDs. In this fashion, a single electrical cord or other conductive material can be connected to a power source and can be used for powering all of the illuminating elements. One or more perimeter strands (421, 422, 423, 424, 425, 426) may be connected to the strands (411, 412, 413, 414, 415, 416) in order to maintain a more stabilized or predictable distance between the strands (411, 412, 413, 414, 415, 416) during use. This can aid in keeping the illuminated helmet cover in place upon a helmet and may help ensure that the illuminating elements are disposed around the helmet as desired, instead of bunching or grouping up at one location, for example, due to environmental forces, like wind.

In one embodiment, the distance or length of strand 414, which connects from the center top point node 430 to the connecting element 404, may be 8 inches. Similarly, the distance or length of strand 415, which connects from the center top point node 430 to the connecting element 405, may be 8 inches. The other remaining strands (411, 412, 413, 416), which connect from the center top point node 430 to their connecting elements (401, 402, 403, 406, respectively), may have a distance or length of 12 inches. In alternative embodiments, any of a variety of distances or lengths may be used.

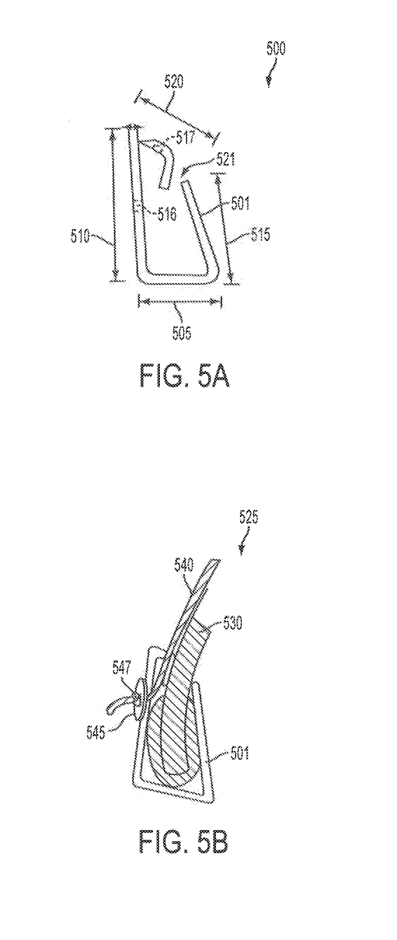

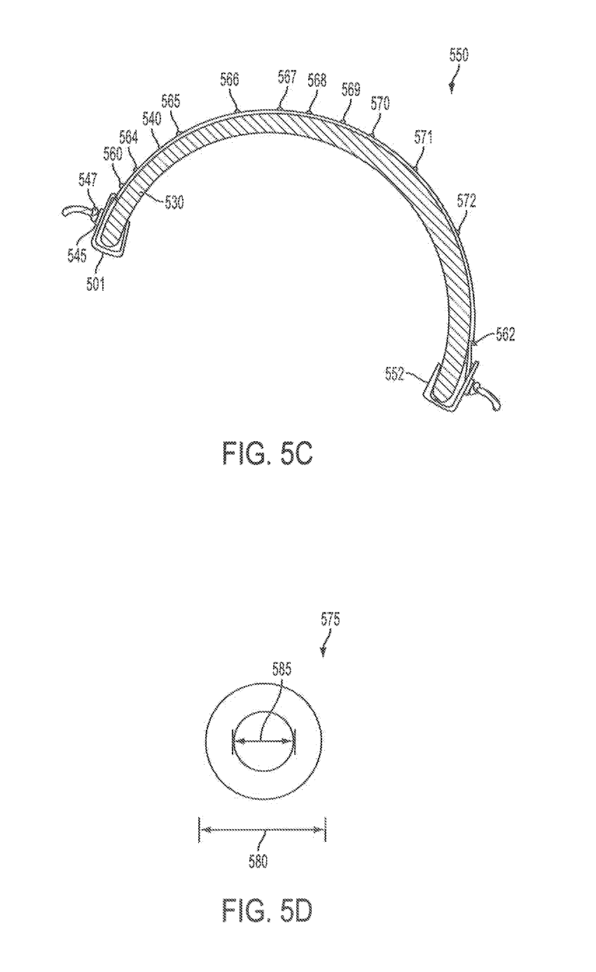

FIG. 5A shows a side view 500 of a clamp 501 for connecting an illuminated helmet cover with a helmet. The clamp 501 and/or the illuminated helmet cover may include features that are the same as or similar to those previously discussed. As further illustrated in FIG. 5B, which shows a side view 525 of the clamp 501 connected with a helmet 530, the damp 501 is configured to fit around a lip or portion of the helmet 530 via an opening 521 of the clamp 501. A first hole 516 is disposed in the clamp 501 and configured to receive one or more strands 540 therethrough. Similarly, a second hole 517 is disposed in the clamp 501 and configured to receive the one or more strands 540. For example, these strands may be strands (411, 412, 413, 414, 415, 416) of FIG. 4. in one embodiment, the clamp 501 may be made of steel and/or some other metal or material (e.g., a rigid material). In other embodiments, any of a variety of different materials, dimensions, and/or shapes may be utilized.

Once the strand 540 is received within the holes (516, 517) of the clamp 501, the strand 540 is fed through a washer 545 and knotted 547 in order to secure the strand 540 with the clamp 501 and with the helmet 530. In this fashion, a user wearing the helmet 530 can connect the illuminated helmet cover to the helmet 530 via positioning the clamp 501 around a bottom lip of the helmet 530 and tighten the strand 540 to the clamp 501 via the washer 545 and the knotting 547 of the strand 540. In one embodiment, the clamp 501 may have a first dimension 510 that may be 20 mm, long, a second dimension 505 that is 10 mm long, a third dimension 515 that is 15 mm long, and a fourth dimension 520 that is 10 mm long. Each of the holds (516, 517) may be 4 mm in diameter. Other embodiments may utilize alternative shapes or dimensions for the clamp 501 and/or the holes (516, 517) of the clamp 501. In still other embodiments, alternative connection methods may be employed for securing the strand 540 with the clamp 501, for example, instead of a knotting 547 of the strand 540, a bolt or other component may cooperate with one or both of the holes (516, 517) to hold the strand 540 in place.

FIG. 5C shows a side view 550 of the clamp 501 of FIG. 5A and a second clamp 552 connected with the helmet 530. The clamps (501, 552) may include features that are the same as or similar to those previously discussed. Thus, as described, for example, in FIGS. 5A and 5B, the strand 540 may be connected with the clamp 501 via the washer 545 and the knotting 547 of the strand 540. The connection of the strand 540 with the second clamp 552 may be the same as or similar to this connection with the clamp 501. A plurality of illuminating elements (564, 565, 566, 567, 568, 569, 570, 571, 572), such as LEDs or other lights, are connected with the strand 540. Therefore, by positioning the clamps (501, 552) around the helmet 530, the plurality of illuminating elements (564, 565, 566, 567, 568, 569, 570, 571, 572) may be positioned adjacent to an exterior surface of the helmet 530 and provide a visual appearance of a lighted helmet.

A first anchor 560 and/or a second anchor 562 (e.g., positioned adjacent to the clamp 501 and the second clamp 552, respectively) may be used to further hold the strand 540 in place at a particular desired position with the helmet 530, For example, the first and/or second anchors (560, 562) may be clips, hooks, etc. that couple with the exterior of the helmet via adhesives, Velcro, suction, etc, and hold a portion of the strand 540 down near the exterior surface of the helmet 530, FIG. 5D shows a top view 575 of a connecting element, such as the washer 545 of FIGS. 5B and 5C, that is used with the clamp 501 and or clamp 552 for connecting with the strand 540. The connecting element may have an outer diameter 580 of 10 mm and an interior diameter 585 of 5 mm. In one embodiment, the connecting element may be made of steel. In other embodiments, any of a variety of different materials, dimensions, and/or shapes may be utilized.

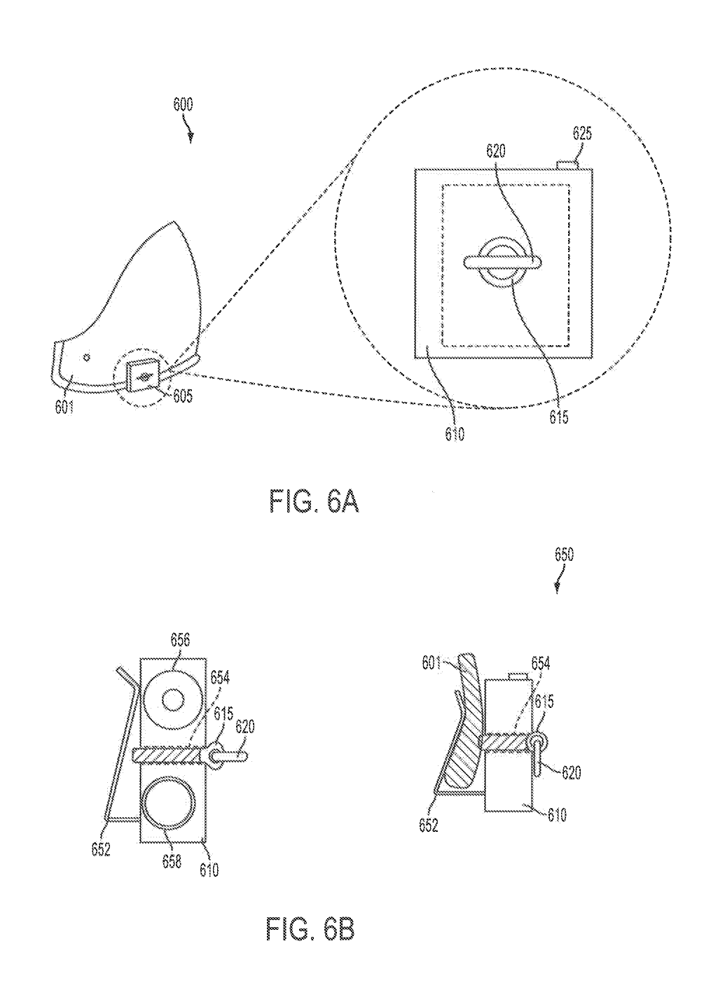

FIG. 6A shows a zoomed-in view 600 of a power source 605 for an illuminated helmet cover for a helmet 601. The power source 605 and/or the illuminated helmet cover may include features that are the same as or similar to those previously discussed. As illustrated the power source 605 may include an exterior case 610 that is configured to fasten or otherwise connect with the helmet 601. The exterior case 610 may be constructed of a variety of materials, including plastic (hard and/or soft), metal, rubber, etc.

With reference to FIG. 6B, which shows side views 650 of the power source 605 connected with the helmet 601, a clasping hook 652 or other connector is configured to engage with a lip or portion of the helmet 601. The exterior case 610 of the power source 605 is connected with the clasping hook 652 so is thus connected with the helmet 601 when the clasping hook 652 is engaged with the helmet 601. In certain embodiments, and as illustrated, the exterior case 610 of the power source 605 may be further secured with the helmet 601 via an opening or hole 654 through the exterior case 610 and a corresponding screw 615 that is received therethrough. Thus, the screw 615 may be tightened such that it makes contact with the helmet 601 when the clasping hook 652 is engaged with a lip or portion of the helmet 601 for increased stability or coupling with the helmet 601.

The screw 615 may include a latching mechanism 620 as part of its head that may be rotated inline or parallel with the opening or hole 654 for screwing of the screw 615 in or out. This latching mechanism 620 may also be rotated to not be inline (e.g., be positioned perpendicular) to the opening or, hole 654 when it is desired for the screw 615 to be maintained in its current position. Not only does such a latching feature allow for a user to manipulate the screw without requiring the user to also have access to tools, such as a screwdriver, but may also aid in keeping the screw 615 in contact with the helmet 601 when screwed in. In an alternative embodiment, a screw without the use of a latching mechanism may be used, or any of a variety of other components may be used to facilitate the pressure of the screw 615 either against or relieved from the helmet 601. As illustrated, two batteries (656, 658) may be capable of fitting within the exterior case 610 of the power source 605 for providing power.

Any of the embodiments discussed for the various figures may include additional controls for allowing user customization or modification of the plurality of lights. For example, a processor may be connected with a power source and/or one or more of the plurality of lights or lighted nodes. This processor may interface with the power source and/or one or more of the plurality of lights to select the color of one or more of the plurality of lights, alter the strobing effect or pattern, etc. A user may be permitted to communicate with the processor (e.g., via software and/or a mobile application on a smart phone, tablet, laptop computer, etc.) to choose the desired characteristics of one or more of the plurality of lights. The processor may also allow for different modes of functionality for the plurality of lights (e.g., a daylight mode where lights or LEDs are brighter versus an evening or nighttime mode where lights or LEDs are dimmer for power conservation). In an alternative embodiment, rather than a processor, a mechanical or electrical switch or other hardware may interface with the power source and/or one of the plurality of lights that allows such above-described. functionality and/or user modification. Similarly, in an alternative embodiment, the positions of the lights, strands or bands, straps, hooks, etc, may be different in an alternative embodiment.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope. Skilled artisans may implement the described functionality in varying ways for each particular application, but such implementation decisions should not be interpreted as causing a departure from the scope of the disclosed apparatus and methods. The steps of the method or algorithm may also be performed in an alternate order from those provided in the examples.

What is claimed is:

1. An illuminated helmet cover, comprising:
an illuminating element;
a strand connected with the illuminating element, the strand configured to extend around at least a portion of the helmet; and
a connecting component configured to engage with the strand and configured to engage with the helmet for holding the strand and the helmet together.

2. The helmet cover of claim 1 wherein the at least one illuminating component is a light emitting diode (“LED”).

3. The helmet cover of claim 1 wherein the at least one illuminating component is a reflective material.

4. The illuminating helmet cover of claim 1 wherein the connecting component is a clamp configured to engage with a lower lip of the helmet.

5. The illuminating helmet cover of claim 4 wherein the clamp includes a hole disposed therethrough for receiving the strand.

6. The illuminating helmet cover of claim 1 further comprising a power source connected with the at least one illuminating element for providing power to the illuminating element.

7. The illuminating helmet cover of claim 6 wherein the power source includes:
an exterior case having an opening disposed therethrough;
a clasp connected with the exterior case and configured to engage with the helmet; and
a screw configured to be received by the opening, the screw configured to rotate in the opening for making contact with the helmet if the clasp is engaged with the helmet.

8. An illuminating helmet cover for a helmet, comprising:
a connecting component configured to engage with the helmet;
a power source configured to engage with the helmet;
a strand configured to connect with the connecting component;
a conductive material connected with the power source and connected with the strand; and
an illuminating element electrically connected with the conductive material and positioned at the connection of the conductive material with the strand.

9. The illuminating helmet cover of claim 8 wherein the connecting component is a clamp configured to fasten to a lower edge of the helmet.

10. The illuminating helmet cover of claim 8 wherein the connecting component is an adhesive configured to adhere to a portion of the helmet.

11. The illuminating helmet cover of claim 8 wherein the strand is made of an elastic material for stretching over at least a portion of the helmet.

12. The illuminating helmet cover of claim 11 wherein the elastic material is a bungee cord.

13. The illuminating helmet cover of claim 8 wherein the conductive material is a stretchable electric cord.

14. An illuminated helmet cover for placement around at least a portion of a helmet, comprising:
a strand made of an elastic material, the strand configured to be placed around at least a portion of the helmet;
an illuminating element that requires power to illuminate, the illuminating element connected to the strand at a node;
a power source for providing power to the illuminating element, the power source including:
an external case, and
a clasp connected with the external case and configured to engage with an edge of the helmet for securing to the helmet;
a wire configured to conduct power from the power source to the illuminating element, the wire connected to the strand at the node;
a clamp configured to connect with the strand and configured to engage with an edge of the helmet for securing to the helmet.

15. The illuminated helmet cover of claim 14 further comprising:
a second strand made of an elastic material, the second strand configured to be placed around at least a portion of the helmet; and
a second illuminating element that requires power to illuminate, the illuminating element connected to the second strand at a second node,
wherein the wire is configured to conduct power from the power source to the second illuminating element, the wire connected to the second strand at the second node.

16. The illuminated helmet cover of claim 14 wherein the power source includes a solar cell.

17. The illuminating helmet cover of claim 14 further comprising a processor interfacing with the power source for modifying a characteristic of the illuminating element.

17. The illuminating helmet cover of claim 17 wherein the processor is configured to cause the illuminating element to strobe.

19. The illuminating helmet cover of claim 17 wherein the processor is configured to cause the illuminating element to change in color.

20. The illuminating helmet cover of claim 8 wherein the processor is configured to cause the illuminating element to change in brightness.
